(19) United States
(12) Patent Application Publication
(10) Pub. No.: US 2006/0288711 A1
(43) Pub. Date: Dec. 28, 2006

(54) Device and method for vaporizing lng

(76) Inventors: Keijiro Yoshida, Hiroshima (JP); Kazumasa Ogura, Hiroshima (JP)

Correspondence Address: BIRCH STEWART KOLASCH & BIRCH, PO BOX 747, FALLS CHURCH, VA, 22040-0747, US

(21) Appl. No.: 10/554,746

(22) PCT Filed: Mar. 8, 2005
(86) PCT No.: PCT/JP05/03959

§ 371 Date: Oct. 28, 2005

(30) Foreign Application Priority Data
Mar. 10, 2004 (JP) 2004-067987

(51) Int. Cl. F17C 9/02

(52) U.S. Cl. 62/50.2

(57) ABSTRACT

An LNG gasifier configured to be installed on an offshore structure for vaporizing LNG includes a water passage into which water flows; an LNG passage provided inside the water passage and configured to pass the LNG and that allows heat exchange between the water and the LNG; and a bubble generating unit configured to generate bubbles of air into the water in the water passage. The water passage has an inlet port from where the water is taken in and a discharge port from where air and the water are discharged.

### TECHNICAL FIELD

The present invention relates to a liquefied-natural-gas (LNG) gasifier and a method of gasification.

### BACKGROUND ART

A liquefied natural gas (LNG), which is liquid methane, is a liquid having a boiling point of about −165° C. The LNG is transported from a liquefaction station by sea with an LNG ship provided with a cryogenic tank. The LNG is handled at on-shore LNG-receiving terminals (stations) near a port of various places to be supplied to customers.

Such LNG-receiving terminals are provided with, for example, an insulated tank to hold the LNG from a ship, a gasifier (vaporizer) to vaporize the LNG to convert into a natural gas (NG), in other words, a heat exchanger, and a controlling and measuring installation that regulates and measures an amount of the LNG supplied to pipeline of a customer.

To serve the LNG at an area without such LNG-receiving terminal, a floating-production-storage-and-offloading (FPSO) vessel is proposed. The FPSO is provided with a gasifier to convert the LNG into the NG at sea. The NG converted from the LNG at sea, for example, on a ship, is supplied through a pipeline to an on-shore pipeline for NG (Patent Literature 1).

An example of an LNG gasifier on a ship is shown in FIG. 4. As shown in FIG. 4, a conventional LNG gasifier includes a pipe 2 to feed the LNG from an LNG storage tank 1. An outer surface of a pipe 2a is brought into contact with a heating medium such as seawater 3. The pipe 2a is surrounded by a tubular shell 4. A seawater pump 5 is provided inside the tubular shell 4 to send the seawater 3 through the shell. A motor 6 is provided in a ship 7 to drive the seawater pump 5. The NG obtained by vaporization is collected in a collection tank 8 and sent to shore by a pipe 9.

Patent Literature 1: Japanese Patent Publication No. 2003-517545

### DISCLOSURE OF INVENTION

Problem to be Solved by the Invention

In the conventional LNG gasifier disclosed in patent literature 1, the seawater pump 5 needs to be provided inside the tubular shell 4 to supply seawater, which is used as a heat source for vaporization. This requires provision of the motor 6 to drive the seawater pump 5 as well as maintenance of the seawater pump 5.

On the other hand, when, for example an open-rack-type LNG gasifier as shown in FIG. 5 that uses seawater for heat exchange is provided in the FPSO, seawater 103 is brought into a seawater trough 101 from a seawater supply port 102. The LNG passing through a heat exchanging tube 104 is vaporized by means of the seawater 103 overflowing from the seawater trough 101. Thus, the open rack type LNG gasifier needs a stable supply of seawater. However, a stable supply of seawater from the seawater trough 101 cannot be maintained due to swaying of the ship.

Providing the FPSO with another type of LNG gasifier such as an LNG gasifier that carries out heat exchange by supplying a gas from a burner to a water cistern requires maintenance of the burner and accompanying combustion facilities. Moreover, this results in a high fuel cost.

Providing the FPSO with still another type of LNG gasifier such as an LNG gasifier that carries out heat exchange by means of an intermediate heating medium requires use of combustible liquefied-petroleum gas (LPG) or chlorofluorocarbon substitute as the intermediate medium. This causes difficult handling, for example, in inspection and maintenance.

It is an object of the present invention to solve the above problems and to provide an LNG gasifier that is simple in structure and enables stable vaporization of LNG in the FPSO, and a method of gasification.

Means for Solving Problem

To solve the above problems, a first invention of the present invention includes an LNG gasifier for vaporizing LNG that includes a seawater inlet passage that is provided in a main unit and into which seawater flows; a heat exchanging tube for causing heat exchange between the seawater and the LNG, the heat exchanging tube provided inside the seawater inlet passage; a bubbling device for supplying air into the seawater, the bubbling device provided near an inlet port of the seawater inlet passage; an air supplying device configured to supply external air to the bubbling device; and a discharge port for discharging bubbling air, which is generated in the bubbling device, outside the main unit, the discharge port configured to communicate with the seawater inlet passage. The bubbling air generated in the bubbling device brings the seawater inside the inlet passage from the seawater inlet port to vaporize the LNG supplied inside the heat exchanging tube.

In a second invention according to the first invention, the seawater inlet passage opens in a vertical axial direction.

In a third invention according to the first invention, the heat exchanging tube includes a spiral shaped tube.

In a fourth invention according to the first invention, the heat exchanging tube includes a flange joint so that the heat exchanging tube is configured to separate into multiple parts.

In a fifth invention according to the first invention, the seawater inlet port is located below the discharge port.

A sixth invention according to the present invention includes a ship that includes the LNG gasifier according to any one of the first to the fifth invention.

A seventh invention according to the present invention includes an offshore structure that includes the LNG gasifier according to any one of the first to the fifth invention.

An eighth invention according to the present invention includes a method of gasification of LNG that includes causing bubbles with air inside a seawater inlet passage provided in a main unit to take in seawater inside the seawater inlet passage; and supplying LNG into a heat exchanging tube provided inside the seawater inlet passage to vaporize the LNG.

### EFFECT OF THE INVENTION

According to the present invention, it is possible to realize stable gasification of an LNG on an FPSO and an LNG gasifier having a simple structure in which a seawater pump required in a conventional LNG gasifier for supplying a heat source is not required.

### BRIEF DESCRIPTION OF DRAWINGS

FIG. 1 is a cross-section of an LNG gasifier according to a first embodiment of the present invention;

FIG. 2 is a plan view of the LNG gasifier according to the first embodiment;

FIG. 3 is a schematic of a ship provided with the LNG gasifier according to a second embodiment of the present invention;

FIG. 4 is a schematic of an LNG gasifier according to a conventional technology; and

FIG. 5 is a schematic of another LNG gasifier according to a conventional technology.

### EXPLANATIONS OF LETTERS OR NUMERALS

10 LNG gasifier

11 main unit

12 seawater

13 seawater inlet passage

14 heat exchanging tube

15 air

16 bubbling device

17 air supplying device

18 discharge port

### BEST MODE(S) FOR CARRYING OUT THE INVENTION

Exemplary embodiments of the present invention are explained in detail below with reference to the accompanying drawings. The present invention is not limited to the embodiments. Structural elements described in the embodiments include all modifications and alternative constructions, which may occur to one skilled in the art.

### First Embodiment

An LNG gasifier according to a first embodiment of the present invention is explained with reference to the accompanying drawings.

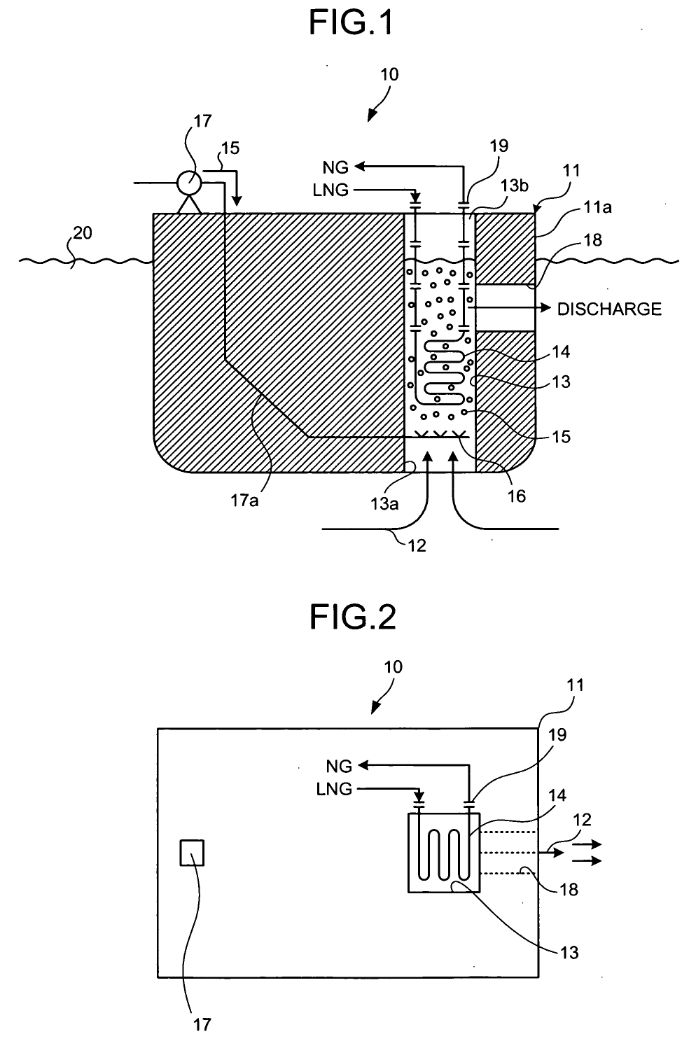

FIG. 1 is a cross-section of the LNG gasifier according to the first embodiment. FIG. 2 is a plan view of the LNG gasifier.

As shown in FIG. 1 and FIG. 2, an LNG gasifier 10 for vaporizing LNG is provided in a main unit 11 immersed in sea 20. Seawater 12 is taken into a seawater inlet passage 13. A heat exchanging tube 14 is provided along an axial direction of a passage inside the seawater inlet passage 13 to cause heat exchange between the seawater 12 and LNG. A bubbling device 16 provided near a seawater inlet port 13a of the seawater inlet passage 13 supplies air 15 to the seawater. An air supplying device 17 continuously supplies the air 15 from outside to the bubbling device 16 through a passage 17a. Through a discharge port 18 communicating with the seawater inlet passage, the air 15 in a form of bubble generated in the bubbling device 16 is discharged out of the main unit 11. The seawater 12 is forcibly brought inside the seawater inlet passage 13 through the seawater inlet port 13a collaterally with movement of the air 15 in bubbles generated in the bubbling device 16. Thus, the LNG supplied inside the heat exchanging tube 14 from an LNG tank is vaporized to an NG.

According to the present embodiment, the seawater inlet passage 13 is formed in such a manner that the seawater inlet passage 13 runs through in a vertical axial direction inside the main unit 11 and has a port 13b that communicates with the outside.

The discharge port 18 is provided on a sidewall 11a of the main unit in such a manner that the discharge port 18 communicates with the seawater inlet passage 13 so that the bubbling air 15 is swiftly discharged.

According to the present embodiment, the heat exchanging tube is, for example, a trombone-shaped spiral tube so that heat exchange efficiency is enhanced. However, the present invention is not to be thus limited, and a tube of any shape having high heat exchange efficiency may be applied.

According to the present embodiment, the heat exchanging tube includes a flange joint 19 and is separable into multiple parts. Thus, the heat exchanging tube 14 can be separated or connected when the heat exchanging tube 14 is to be inserted into or removed from the seawater inlet passage, thereby making insertion or removal of the heat exchanging tube easier.

According to the present embodiment, the seawater inlet port 13a is located below the seawater discharge port 18, thereby increasing efficiency in supplying seawater and increasing the heat exchange efficiency.

According to the present embodiment, the air supplying device 17 supplies air to the bubbling device 16, and an airlift force of the bubbling causes the seawater 12 to be brought inside the seawater inlet passage 13. Then, LNG is supplied into the heat exchanging tube 14. Thus, heat exchange is caused between the LNG and the seawater to vaporize the LNG into NG.

According to the present embodiment, providing the LNG gasifier, for example, to a ship to be an FPSO, it is possible to realize a stable vaporization of LNG. Thus, an LNG gasifier that has a simple structure in which a seawater pump for supplying a heat source, which is required in a conventional LNG gasifier, is not required can be provided.

According to the present embodiment, the seawater is forcibly brought into the seawater inlet passage by supplying air to the bubbling device. Unlike the conventional technology, a heat source such as a burner is not needed, and use of an intermediate medium (LNG or chlorofluorocarbon substitute) is not required. Thus, inspection and maintenance can be easily carried out, and a stable supply of seawater can be maintained without being affected by swaying of the ship at sea.

### Second Embodiment

A ship provided with an LNG gasifier according to a second embodiment of the present invention is explained with reference to the accompanying drawings.

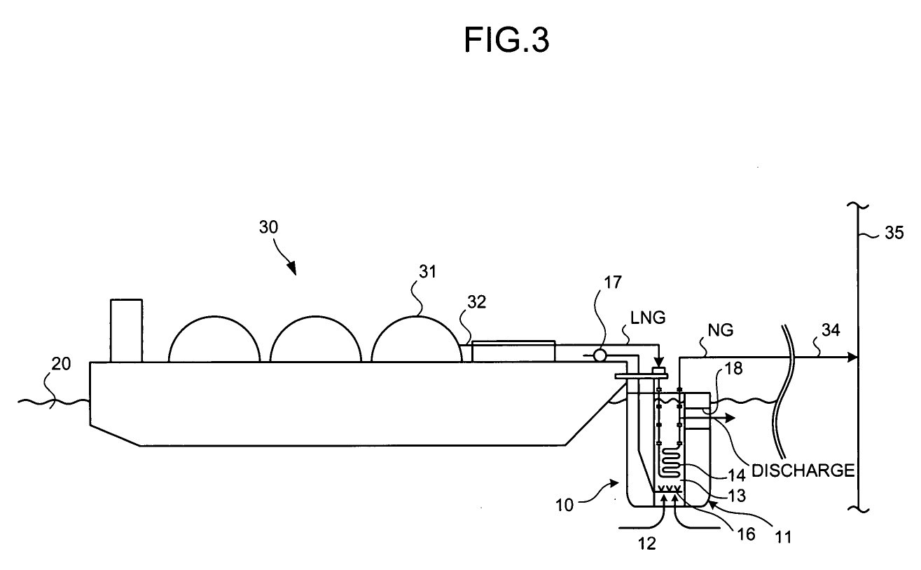

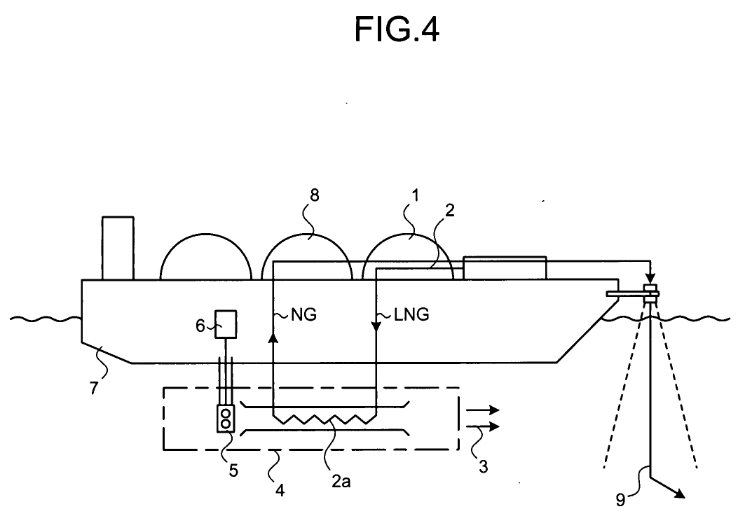

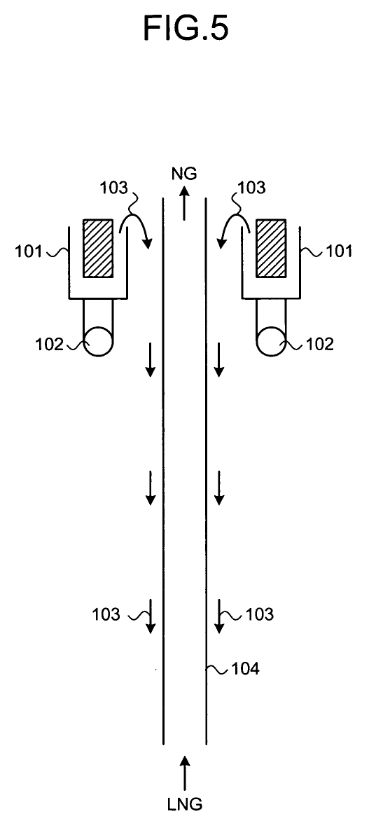

FIG. 3 is a schematic of the ship provided with the LNG gasifier according to the second embodiment.

As shown in FIG. 3, the LNG gasifier 10 is arranged at a bow of a ship 30 according to the present embodiment. The LNG supplied from an LNG tank 31 via a pipe 32 is vaporized in the LNG gasifier 10 and supplied to an on-shore pipeline 35 via a pipeline 34.

Thus, LNG can be stably vaporized and supplied as NG even to a place on the shore without an LNG receiving terminal. Moreover, the NG supplied can be directly supplied to the on-shore pipeline.

According to the present embodiment, it is possible to vaporize the LNG with a simple structure using the LNG gasifier arranged at the bow of the ship, and to directly supply the NG obtained by vaporization to the on-shore pipeline 35.

While in the present embodiment, the LNG gasifier shown in FIG. 1 is provided on the ship, the present invention is not thus limited and the LNG gasifier may also be provided on a marine structure located offshore.

### INDUSTRIAL APPLICABILITY

The LNG gasifier and method for LNG gasification according to the present invention can be applied to ships or offshore structures that include an LNG gasifier.

1-8. (canceled)

9. A liquefied natural gas (LNG) gasifier configured to be installed on an offshore structure for vaporizing LNG, comprising:
a water passage into which water flows, wherein the water passage has an inlet port from where the water is taken in and a discharge port from where air and the water are discharged;
an LNG passage provided inside the water passage and configured to pass the LNG and that allows heat exchange between the water and the LNG; and
a bubble generating unit configured to generate bubbles of air into the water in the water passage.

10. The LNG gasifier according to claim 9, wherein the water passage is substantially perpendicular to a surface of water on which the offshore structure floats.

11. The LNG gasifier according to claim 9, wherein the LNG passage includes a spiral tube.

12. The LNG gasifier according to claim 9, wherein the LNG passage is configured to separate into multiple parts.

13. The LNG gasifier according to claim 9, wherein the inlet port is located below the discharge port with respect to a surface of water on which the offshore structure floats.

14. The LNG gasifier according to claim 9, wherein the bubble generating unit is provided inside the water passage near the inlet port

15. An offshore structure comprising an LNG gasifier that includes
a water passage into which water flows, wherein the water passage has an inlet port from where the water is taken in and a discharge port from where air is discharged with the water;
an LNG passage provided inside the water passage and configured to pass the LNG and that allows heat exchange between the water and the LNG; and
a bubble generating unit configured to generate bubbles of air into the water in the water passage.

16. The offshore structure according to claim 15, wherein the offshore structure includes a ship.

17. A method of gasification of LNG, comprising
generating bubbles of air in water inside a water passage; and
passing LNG into an LNG passage provided inside the water passage and that allows heat exchange between the water and the LNG.
